(19) United States
(12) Patent Application Publication
(10) Pub. No.: US 2015/0182888 A1
(43) Pub. Date: Jul. 2, 2015

(54) WASTEWATER COMPACTOR WITH ADJUSTABLE BRUSH SCREEN FILTER

(71) Applicant: Headworks, Inc., Houston, TX (US)

(72) Inventors: Joseph Jean Beaupre, Houston, TX (US); Ronald Calvin Buede, Houston, TX (US)

(21) Appl. No.: 14/588,019

(22) Filed: Dec. 31, 2014

Related U.S. Application Data
(60) Provisional application No. 61/922,381, filed on Dec. 31, 2013.

(51) Int. Cl. B01D 33/00

(52) U.S. Cl. CPC B01D 33/0067

(57) ABSTRACT

A screening compactor for wastewater applications is provided. The screening compactor includes a drive unit and a shaft rotatably coupled to the drive unit. The screening compactor further includes a brush coupled to the shaft and configured to rotatably filter debris. The screening compactor additionally includes an adjustable brush screen filter disposed about the brush. The adjustable brush screen filter includes a plurality of openings disposed on a lower portion of the adjustable brush screen, and at least one slot disposed on an upper portion of the adjustable brush screen filter. The at least one slot is configured to fasten the adjustable brush screen filter to the screening compactor.

This application is a Non provisional patent application of U.S. Provisional Patent Application No. 61/922,381, entitled “WASTEWATER COMPACTOR WITH ADJUSTABLE BRUSH SCREEN FILTER”, filed Dec. 31, 2013, which is incorporated herein by reference in its entirety.

### BACKGROUND OF THE INVENTION

The subject matter disclosed herein relates to the field of wastewater treatment, and more particularly to an adjustable brush filter for use in such applications that provides for an improved wastewater compactor.

In the field of wastewater treatment, a range of components are used at various stages of water capture and processing, ultimately resulting in treated water that may be used or released into the environment. One component that is often used in a wastewater collection and treatment system is a screening compactor. These devices allow for wastewater “screenings” to flow into a compactor assembly which compacts the screening material while allowing strained wastewater to flow through for further filtering and treatment. In one type of screening compactor, one or more brushes may be used to continuously brush material that is being collected from the wastewater sludge. Typically, compacting and water removal operations may be performed without operator intervention, at least during times when wastewater sludge is flowing through the system. The compacted material may then be disposed of accordingly. Persistent problems in such devices may result from an increased wear of the brushes, resulting in a loss of effective brushing of the screenings. There is need, therefore, for improved techniques to manage the wear and tear on brushes.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a screening compactor for wastewater applications is provided. The screening compactor includes a drive unit and a shaft rotatably coupled to the drive unit. The screening compactor further includes a brush coupled to the shaft and configured to rotatably filter debris. The screening compactor additionally includes an adjustable brush screen filter disposed about the brush. The adjustable brush screen filter includes a plurality of openings disposed on a lower portion of the adjustable brush screen, and at least one slot disposed on an upper portion of the adjustable brush screen filter. The at least one slot is configured to fasten the adjustable brush screen filter to the screening compactor.

In a second embodiment, a retrofit kit for a screening compactor for wastewater applications includes an adjustable brush screen filter. The adjustable brush screen filter includes a plurality of openings disposed on a lower portion of the adjustable brush screen and at least one slot disposed on an upper portion of the adjustable brush screen filter, wherein the at least one slot is configured to fasten the adjustable brush screen filter to the screening compactor. The retrofit kit further includes a fastener configured to fasten the adjustable brush screen filter to the screening compactor via the at least one slot.

In a third embodiment, a system is provided. The system includes a wastewater compactor system having a drainage area. The system further includes an adjustable brush screen filter. The adjustable brush screen filter includes a plurality of openings disposed on a lower portion of the adjustable brush screen. The adjustable brush screen filter additionally includes at least one slot disposed on an upper portion of the adjustable brush screen filter, wherein the plurality of openings are disposed above the drainage area.

The present invention provides for a novel brush filter screen or trough suitable for adapting to a variety of screening compactor designs and techniques. The brush filter screen may include kit embodiments used to retrofit exiting compactors that do not have such a device. In other embodiments, the compactor system may be manufactured to include the brush filter screen. Regardless of embodiment, the brush filter screens described herein may be disposed to surround and perhaps abut one or more brushes used to move screening material into compacting portions of the screening compactor. The screening material may include a variety of detritus that may be found in waste, including conventional or unconventional screening material, such as bricks, wood pieces, cans, plastic containers, articles of clothing, fabric material, and so on.

Prior to the techniques disclosed herein, as the brushes rotated to clear and/or to move the screenings, contact of brushes against screen material, screens, or troughs would result in brush wear. Eventually, the brush wear would lead to loss of efficiency of the system because the brush bristles may have shortened, thus not moving as much screenings as before, or not moving certain screening types such as fabrics. Accordingly, the brushes may have been replaced even though the brush bristles may still have a substantial operating life remaining. Advantageously, the brush screens described herein provide for adjustment in certain desired geometries so as to maintain a substantially similar distance or an abutment between the brush bristles and the brush screen as the bristles of the brush wear down. Accordingly, screenings, e.g., debris, may be captured by the brush in substantially the same manner, thus maintaining approximately the same flow of screenings through the screening compactor as described in more detail below. Additionally, techniques may be provided suitable for minimizing the labor involved in adjusting the adjustable brush screens. For example, the brush screens may be adjusted externally to the screening compactor and without having to remove the brush. Accordingly, a more efficient and maintainable screening compactor may be provided using the techniques described herein.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a first screening compactor employing an adjustable brush screen filter in accordance to one aspect of the invention;

FIG. 2 is a perspective view of an embodiment of a second screening compactor employing the adjustable brush screen filter in accordance to one aspect of the invention;

FIG. 3 is a cross-sectional view of an embodiment of the screening compactor of FIG. 2 and a retrofit kit having the adjustable brush screen filter;

FIG. 4 is perspective view on an embodiment of the adjustable brush screen filter;

FIG. 5 is a frontal view of an embodiment of the adjustable brush screen filter of FIG. 4 disposed about a brush;

FIG. 6 is a frontal view of an embodiment of the adjustable brush screen filter of FIG. 5 adjusted to more comformably fit the brush;

FIG. 7 is a frontal view of embodiments of various shapes that the adjustable brush screen filter may be manufactured into; and

FIG. 8 is a side view on an embodiment of visual markings and a slot useful in attaching the adjustable brush screen filter to a side wall of the screening compactors of FIGS. 1 and 2.

### DETAILED DESCRIPTION OF THE INVENTION

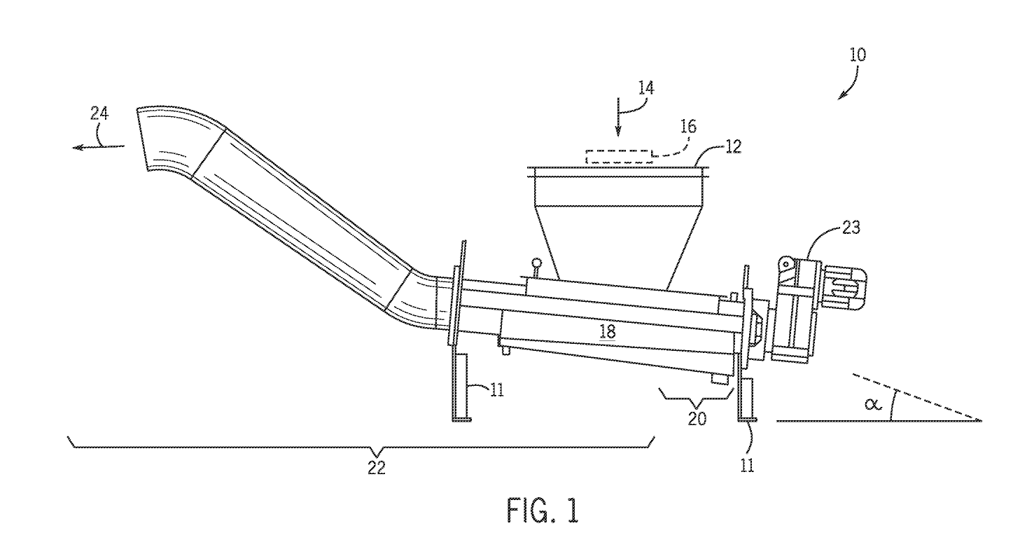

It may be useful to describe certain screening compactors suitable for using the techniques described herein. Accordingly, FIG. 1 is a perspective view of a screening compactor system 10 that would be used in a wastewater treatment facility. As will be appreciated by those skilled in the art, the compactor system 10 may be positioned at an angle α of a collection point screenings that may be incoming from a screening filter or other similar device of a treatment facility. The angle α may be adjusted from 0° to upwards of 60° of more, for example, by adjusting the height of legs 11. An open end 12 of the compactor system 12 receives a flow of screening wastewater as indicated by arrow 14. Screenings 16 may include debris such as wood pieces, bricks, shoes, fabric, articles of clothing, rope, and so on.

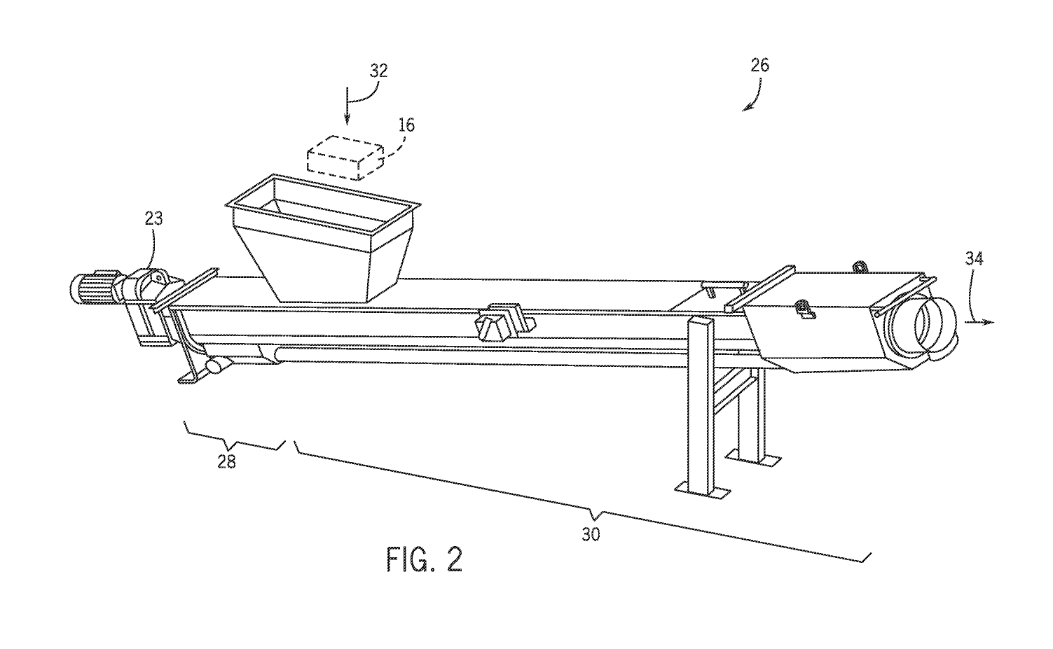

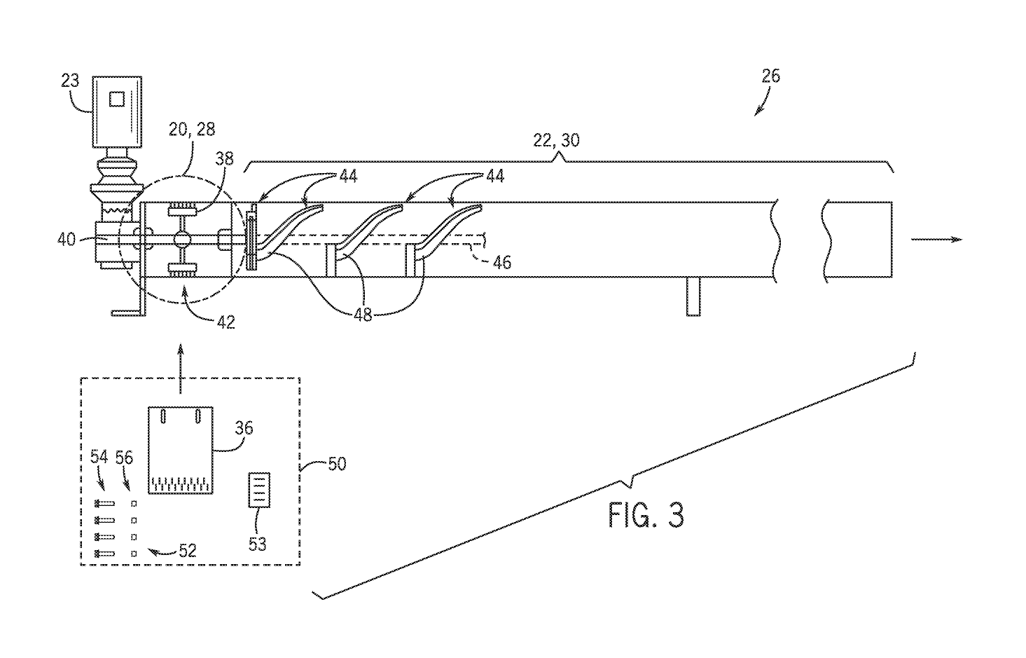

The screenings 16 may then enter a portion 18 of the compactor system 12 for further processing. In particular, the section 18 may include a drain and an adjustable brush screen as shown in more detail and described with respect to FIG. 3 below useful in adjusting to match, for example brush wear and tear. Portion 22 of the compactor system 10 may then provide systems to compact and move the now compacted debris 16 for further disposal and/or bagging. As illustrated a drive unit, e.g., motor 23 may be used to provide a rotative force useful in driving the systems of the compactor 12. Arrow 24 indicates the exit of the compacted debris 16, which may then be bagged or otherwise disposed as provided by regulatory agencies or local laws. The systems described herein may be used in a variety of compactors 10, including but not limited to systems that use either a shaftless compactor/conveyor, a shafted compactor/conveyor, or a combination thereof. For example, FIG. 2 is an embodiment of a second compacting system 26 that may also use the techniques described herein.

As shown in FIG. 2, the compacting system 26 may also include portions 28 and 30 similar in use to portions 20 and 22 of the compacting system 10. More specifically, portion 28 may be used to drain water from the debris 16 after the debris 16 has entered the compactor 26 as indicated by arrow 32. The portion 30 may then rotatably compact and convey the debris 16, for example when driven by the drive unit 23. Compacted debris 16 may then exit the compactor system 26 as indicated by arrow 34, for bagging and/or further disposal. Turning now to FIG. 3, the figure is a cross-sectional view of an embodiment of the screening compactor 26 showing the portions 28 and 30 in more detail. It also to be noted that the techniques described herein may be applied to other compactor systems, such as the compactor system 10 of FIG. 1 having the sections 20 and 22. Also depicted as removed from the system 26 is an adjustable brush screen filter 36. During manufacture or during a retrofit, the adjustable brush screen filter 36 may be inserted into portions 20, 28 and used to adjust the compactors 10, 26 as a brush 38 or multiple brushes 38 exhibit wear during their operating life.

In the example shown, the drive unit 23 is rotatably coupled to a shaft 40 and used to rotate the shaft 40 as the debris 16 is processed by the compactors 10, 26. The rotation of the shaft 40 may then also rotate the brush or brushes 38, thus providing for removal of the debris 16 from a drain area 42. It is to be understood that the brush or brushes 38 may include a number of embodiments as further described below, including embodiments were a single brush 38 is disposed so that the brush's center is concentric with the shaft 40 as described in more detail with respect to FIG. ??. The shaft 40 may also be rotatably coupled to a shafted or a shaftless conveyor system 44. For example, when using a shafted conveyor, the shaft 40 may include a shaft extension 46. When using the shaftless conveyor system 44, the shaftless extension 46 may not be used and the shaft 40 may instead rotate a cylinder having spiraled walls 48. Regardless of shaftless or shafted embodiment, or the location of the portions 20, 28 having the brush 38, the adjustable brush screen filter 36 may be disposed to provide for adjustment, for example, as the brush 38 exhibits wear.

As mentioned above, in one embodiment, the adjustable brush screen filter 36 may be included in a brush retrofit kit 50 suitable for retrofitting the compactors 10 and/or 26 to add the adjustable brush screen filter 36. In the depicted embodiment, the retrofit kit 50 includes the adjustable brush screen filter 36 and one or more fasteners 52. The retrofit kit 50 may also includes instructions 53 detailing how to install the retrofit kit 50 to an existing compactor system 10 and/or 26. The fasteners 52 may include adjustable fasteners such as bolts 54 and corresponding nuts 56. During a retrofit, the adjustable brush screen filter 36 may be disposed onto the portions 20, 28 and then adjusted, for example, by using the fasteners 52 to provide a more uniform brushing of the debris 16. The instructions 53 may provide for instructions to drill openings on to the portions 20, 28 useful in attaching the adjustable brush screen filter 36 to the portions 20, 28, as well as torque values useful in attaching the adjustable brush screen filter 36 to the portions 20, 26.

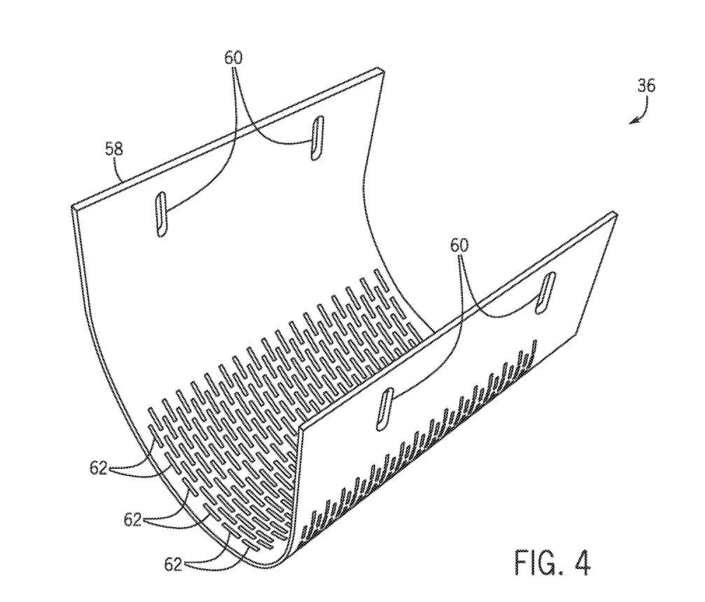

Turning now to FIG. 4, the figures is a perspective view of an embodiment of the adjustable brush screen filter 36 manufactured, for example, out of sheet metal. More specifically, a metal sheet 58 may be bent or otherwise molded to fit contours of the brush 38 and/or portions 20, 28. The metal sheet 58 may include a thickness of between gauge 3 to gauge 36. A thicker metal sheet 58 may increase durability of the system 10, 26, while a thinner metal sheet 58 may increase ease of manufacturing the adjustable brush screen filter 36. In the depicted embodiment, the metal sheet 58 includes a “U” shaped contour useful in enveloping the brush 38 when the brush 38 is provided as a circular brush. It is to be understood that other shapes can be provided for the metal sheet 58, including oval shapes, circular shapes, and so on.

An upper portion of the adjustable brush screen filter 36 may include one or more slots 60 useful in mating with the fasteners 52. For example, bolts 54 may be inserted through the slots 60 and through similar openings on walls of the portions 20, 28, and then attached by applying a torque force to secure the bolts 54 to a suitable torque value. A bottom portion of the adjustable brush screen filter 36 may include a plurality of openings 62 useful in shedding or expelling water. For example, water incoming with the debris 16 or used to wash the debris 16 may be expelled through gravity via the openings 62. The openings 62 may be provided in a variety of shapes, for example, round shapes, oval shapes, teardrop shapes, and the like. By more comformably adjusting a fit of the brush 38, the adjustable brush screen filter 36 may improve the efficiency of the compactor systems 10 and 26.

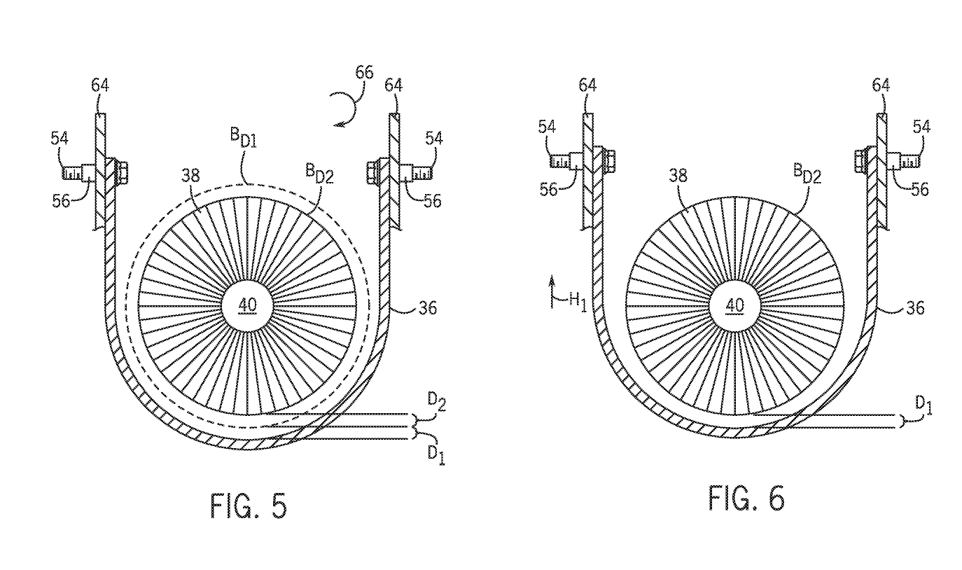

FIG. 5 is a frontal view of the brush 38 disposed concentrically onto the shaft 40 with the adjustable brush screen filter 36 positioned about the brush 38. Also depicted are the nuts 56 threaded onto the bolts 54 to secure or otherwise fasten the adjustable brush screen filter 36 to side walls 64 included in the portions 20, 28. Only sections of the side walls 64 are shown. That is, the walls 64 may include portions so as to completely envelop the adjustable brush screen filter 36.

As the brush 38 is caused to rotate, for example, in a clockwise direction 66, the brush 38 may impinge certain debris 16, thus clearing drainage slots (e.g., openings 62 positioned above drainage area 42 shown in FIG. 3). Unfortunately, the bristles of the brush 38 may wear out during use. For example, when new, the brush 38 may have included a diameter B_{D1}. After certain usage hours, the brush 38 may now include a brush diameter B_{D2} smaller than B_{D1}, as illustrated. Accordingly, when new, a desired distance between the brush 38 and the adjustable brush screen filter 36 may be of D₁ or less. However, after use, the distance between the brush 38 and the adjustable brush screen filter 36 may now be of D₂ greater than D₁. As the brush 38 rotates, certain of the debris 16 may not be as efficiently removed from the drainage area 42, or in some cases, may clog the drainage area 32 due to the increased distance D₂. Advantageously, the adjustable brush screen filter 36 may be used to maintain the desired distance D₁ even after the brush 38 exhibits wear. For example, the nuts 56 may be loosened from the bolts 54 and the adjustable brush screen filter 36 may be repositioned, as shown in FIG. 6.

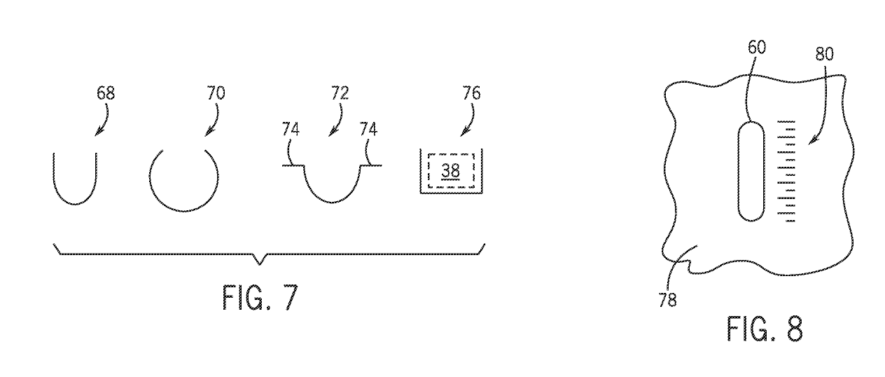

More specifically, FIG. 6 depicts and embodiment of the adjustable brush screen filter 36 after raising the adjustable brush screen filter 36 by a height H₁. By raising the adjustable brush screen filter 36, the brush 38 having the diameter B_{D2} may now be positioned at the desired distance D₁. Accordingly, the brush 38 may operate substantially the same as before, and may sweep substantially the same amount and type of the debris 16. It is to be noted that the adjustable brush screen filter 36 may be provided in a variety of sizes and shapes, as shown in more detail in FIG. 7. For example, the adjustable brush screen filter 36 may be provided in a U-shape 68, a circular or partial circle shape 70, a flared U-shape 72 having ledges 74, or a square shape 76. The ledges 74 may be useful in embodiments where the compactor includes open portions 20, 28 so that the ledges 74 may rest on exterior surfaces of the portions 20, 28. Likewise, the square shape 76 may be useful when the brush or brushes 38 are disposed transversal (e.g., perpendicular) to the side walls 64 rather than axial (e.g., parallel) to the side walls 64. By providing for the various shapes 68, 70, 72, and/or 76, the adjustable brush screen filter 36 may be more comformably disposed inside of side walls 64 having complementary shapes.

Turning now to FIG. 7, the figure is an embodiment of one of the slots 60 disposed onto a portion 78 of the adjustable brush screen filter 36 with a plurality of markings 80 useful in adjusting, for example, the height of the adjustable brush screen filter 36. In one embodiment, the markings 80 may include units of measure, such as international standard metric units of measure (e.g., millimeters, centimeters) and/or U.S. customary units of measure (e.g., fractions of inches, inches). Accordingly, an operator for the compactor 10 and/or 26 may easily inspect the current position of the fasteners 52 and adjust the adjustable brush screen filter 36 as desired. In another embodiment, the markings 80 may include units of use markings 80, such as hours of use. For example, after the brush 38 has been used for 10 hours, the operator may move the adjustable brush screen filter 36 so that the fasteners 52 are positioned by a marking 80 labeled “10 hours.” Similarly, markings 80 labeled “100 hours”, “200 hours”, “500 hours”, “1000 hours”, and so on, may be provided. By providing for the markings 80, the adjustable brush screen filter 36 may be more precisely and easily positioned in relation to the brush 38.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A screening compactor for wastewater applications, comprising:
a drive unit;
a shaft rotatably coupled to the drive unit;
a brush coupled to the shaft and configured to rotatably filter debris; and
an adjustable brush screen filter disposed about the brush, the adjustable brush screen filter comprising:
a plurality of openings disposed on a lower portion of the adjustable brush screen; and
at least one slot disposed on an upper portion of the adjustable brush screen filter, wherein the at least one slot is configured to fasten the adjustable brush screen filter to the screening compactor.

2. The screening compactor of claim 1, wherein the adjustable brush screen filter comprises a metal sheet having a contour.

3. The screening compactor of claim 2, wherein the contour comprises a “U” shape.

4. The screening compactor of claim 2, wherein the metal sheet comprises a gauge of between 3 and 36.

5. The screening compactor of claim 1, comprising a fastener configured to mate with the at least one slot to fasten the adjustable brush screen filter to side walls of the screening compactor.

6. The screening compactor of claim 5, wherein the fastener comprises a bolt and a matching threaded nut.

7. The screening compactor of claim 1, comprising a plurality of visual markings disposed besides the at least one slot indicative of the position of the adjustable brush screen filter with respect to the brush.

8. A retrofit kit for a screening compactor for wastewater applications, comprising:
an adjustable brush screen filter, comprising:
a plurality of openings disposed on a lower portion of the adjustable brush screen; and
at least one slot disposed on an upper portion of the adjustable brush screen filter, wherein the at least one slot is configured to fasten the adjustable brush screen filter to the screening compactor; and
a fastener configured to fasten the adjustable brush screen filter to the screening compactor via the at least one slot.

9. The retrofit kit of claim 8, comprising instructions detailing installation of the adjustable brush screen filter to the screening compactor.

10. The retrofit kit of claim 8, wherein the fastener comprises a bolt and a matching nut combination, and wherein the bolt is sized to traverse the at least one slot and the nut is sized to fasten the bolt to the adjustable brush screen filter and to a side wall of the screening compactor.

11. The retrofit kit of claim 8, comprising a plurality of visual markings disposed besides the at least one slot indicative of the position of the adjustable brush screen filter with respect to a brush included in the screening compactor.

12. The retrofit kit of claim 8, wherein the plurality of visual markings comprise units of measure, units of use, or a combination thereof.

13. The retrofit kit of claim 8, wherein the adjustable brush screen filter comprises a metal sheet having a contour complementary to side walls of the screening compactor.

14. The retrofit kit of claim 13, wherein the contour comprises a U-shape, a partial circle shape, a shape having ledges, or a square shape.

15. A system, comprising:
a wastewater compactor system having a drainage area; and
an adjustable brush screen filter comprising:
a plurality of openings disposed on a lower portion of the adjustable brush screen; and
at least one slot disposed on an upper portion of the adjustable brush screen filter, wherein the plurality of openings are disposed above the drainage area.

16. The system of claim 15, wherein the wastewater compactor system comprises a brush attached to a shaft and wherein the adjustable brush screen filter is disposed about the brush.

17. The system of claim 15, wherein the adjustable brush screen filter comprises a metal sheet.

18. The system of claim 17, wherein the metal sheet comprises a shape molded or bent to follow a contour of side walls of the wastewater compactor system.

19. The system of claim 17, wherein the shape comprises a U-shape, a partial circle shape, a ledge shape, or a square shape.

20. The system of claim 18, comprising a blot and a matching nut, wherein the at least one slot comprises a size suitable for the insertion of the bolt, and the bolt and nut are fastened together to attach the adjustable brush screen filter to the wastewater compactor system.
